(19) United States
(12) Patent Application Publication
(10) Pub. No.: US 2015/0170296 A1
(43) Pub. Date: Jun. 18, 2015

(54) USE OF SOCIAL INTERACTIONS TO PREDICT COMPLEX PHENOMENA

(71) Applicant: UNIVERSITY OF ROCHESTER, Rochester, NY (US)

(72) Inventors: Henry Kautz, Rochester, NY (US); Adam Sadilek, San Jose, CA (US)

(73) Assignee: UNIVERSITY OF ROCHESTER, Rochester, NY (US)

(21) Appl. No.: 14/413,722

(22) PCT Filed: Jul. 9, 2013
(86) PCT No.: PCT/US2013/049691

§ 371 Date: Jan. 9, 2015

Related U.S. Application Data
(60) Provisional application No. 61/669,301, filed on Jul. 9, 2012.

(51) Int. Cl. G06Q 50/00; G06Q 10/00

(52) U.S. Cl. CPC G06Q 50/01; G06Q 10/00

(57) ABSTRACT

Systems and methods for using social network information to predict complex phenomena. According to one embodiment the system or method comprises a Support Vector Machine classifier utilized to infer a pre-determined state of an individual, location, or event based on information gathered from a social network dataset. A conditional random field model can then be used to predict an individual's propensity toward that pre-determined state using features derived from the social network dataset. Performance of the conditional random field model can be enhanced by including features that are not only based on the status of net work connections, but are also based on the estimated encounters with individuals having the pre-determined state, including individuals other than network connections.

### CROSS-REFERENCE TO RELATED APPLICATIONS

This application claims priority to U.S. Provisional Patent Application Ser. No. 61/669,301, filed on Jul. 9, 2012 and entitled “Use of Social Media to Predict an Individual's Response,” the entire disclosure of which is incorporated herein by reference.

### STATEMENT REGARDING FEDERALLY SPONSORED RESEARCH

This work was supported by the Army Research Office Grant No. W911NF-08-1-0242, the Office of Naval Research Grant No. N00014-11-10417, and the Office of the Secretary of Defense Grant No. W81XWH-08-00740. The United States Government has certain rights in the invention.

### BACKGROUND

The present specification relates to computational epidemiology, and, more specifically, to methods and systems for using social network information to predict complex phenomena.

### DESCRIPTION OF THE RELATED ART

Together with the current boom of information technology there has been an explosion in the amount and richness of data recorded. The necessary ingredients for this phenomenon have been fully realized only recently: ubiquitous Internet connectivity, virtually limitless data storage, and powerful mobile devices. Crucially, all the ingredients are inexpensive, widely available, and the technology behind them reached a level of maturity where the general population—not just a handful of hackers—uses the devices in everyday life. As a result, Internet-enabled phones and other mobile computers are used by nearly everyone, even in less developed parts of the world. A typical phone has a large array of sensors that can record location, orientation, acceleration, light intensity, Bluetooth and Wi-Fi neighborhoods, temperature, and audio. Images and video can often be captured as well.

At the same time, the social aspects of computing are gaining prominence. In 2011, for example, the average Facebook user spent nearly 7 hours and 45 minutes on the site per month—more than on any other single site on the Internet. Indeed, the average amount of time a person spends online per month is 30 hours.

Since many smart phone users regularly access online social networks from their phone, some of the fine-grained sensory data the mobile devices record is now linked to the rich structured data in people's online profiles. This includes the text of their messages, tags attached to photos and status updates, and the structure of their social network. For instance, a large fraction of online communication is geo-tagged with precise GPS coordinates and interlinked with information about related people, their location, their friends' location and content, and so on.

Since most people carry a phone in their pockets virtually all the time, and since a large fraction of the population participates in online social media, it becomes possible to quantify—at a planetary scale—phenomena that have been elusive until now. Predicting the spread of disease is a specific instance of phenomena in this class. With so much of the population already participating in social media, and with that number constantly increasing, it will be possible to have real-time access to detailed information about a significant fraction of the population. These people can be viewed as “noisy sensors” of their surroundings, thereby enabling inference even about phenomena not directly recorded online or in government statistics.

A combination of machine learning and crowd sourcing is now poised to effectively answer questions that, at present, require years of laborious and expensive data collection. Moreover, the field is no longer limited by the static and coarse-grained nature of the traditional statistics. However, new challenges are introduced as well, including, among other things, the efficient unification and data mining of diverse, noisy, and incomplete sensory data over large numbers of individuals.

### BRIEF SUMMARY

Systems and methods for predicting an individual's propensity for a state using social media content items. According to one aspect, a method for for predicting an individual's propensity for a state using social media content items, the method implemented by a computer having a processor and system memory, the method comprising: (i) identifying a plurality of social media content items, each social media content item comprising an author, wherein at least one of the social media content items comprises location information; (ii) creating a subset of the identified plurality of social media content items, wherein said subset comprises social media content items that indicate that the author comprises said state, and that comprises location information; (iii) determining whether the individual was co-located in space with one or more of the authors in the subset; (iv) calculating a confidence score indicative of the individual's propensity for the state based on the co-location determination; and (v) delivering the individual's propensity for the state to the individual.

According to another aspect, a system for predicting an individual's propensity for a state using social media content items, the system comprising: (i) a computer having a processor and system memory; (ii) a plurality of social media content items, each social media content item comprising an author, wherein at least one of the social media content items comprises location information; and (iii) a classifier adapted to create in said system memory a subset of the identified plurality of social media content items, wherein the subset comprises social media content items that indicate that the author comprises the state, and that comprises location information; (iv) a determination engine adapted to determine whether the individual was co-located in space with one or more of the authors in the subset; and (v) a calculator adapted to calculate a confidence score indicative of the individual's propensity for the state based on the co-location determination.

According to a third aspect, a method for predicting an individual's propensity for a health condition using social media content items, the method implemented by a computer having a processor and system memory, the method comprising: (i) identifying a plurality of social media content items, each social media content item comprising an author, wherein at least one of said social media content items comprises location information; (ii) tokenizing said identified plurality of social media content items; (iii) creating a subset of said identified plurality of social media content items using a support vector machine binary classifier, wherein said subset comprises social media content items that indicate that the author comprises said health condition, and that comprises location information; (iv) determining whether the individual was co-located in space with one or more of the authors in said subset within a predetermined period of time; (v) determining whether one or more of the authors in said subset have a connection to said individual; (vi) calculating a confidence score indicative of the individual's propensity for said health condition based on said co-location and connection determinations; and (vii) delivering the individual's propensity for said health condition to said individual.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a heatmap schematic of Twitter users' movement within New York City, capturing a sample distribution of geo-tagged messaging on a weekday afternoon, where the hotter—or more red—an area is the more people have recently tweeted from that location;

FIG. 2 is a schematic representation of a social network consisting of the geo-active users, created using LaNet-vi package implementing k-core decomposition, where edges between nodes represent friendships on Twitter, the coreness of nodes is color-coded using the scale on the right, and the degree of a node is represented by its size shown on the left;

FIG. 3 is a table of the summary statistics of data collected from geo-active users in NYC and LA, where a geo-active user is one who geo-tags his/her tweets relatively frequently (more than 100 times per month), and a significant location is defined as one that was visited at least five times by at least one person;

FIG. 4 is a diagram of cascade learning of SVMs, where the symbols [symbol] and

[symbol]

denote thresholding of the classification score, and where the bottom 10% of the scores predicted by Cₒ (i.e., tweets that are normal with high probability) and the top 10% of scores predicted by Cₛ (i.e., likely “sick” tweets) are selected;

FIG. 5A is a graph demonstrating that being co-located with symptomatic individuals and having sick friend on a given day (t) makes one more likely to get sick the next day (t+1), where on the horizontal axis is plotted the amount of co-location of an asymptomatic user with known sick people on a given day;

FIG. 5B is similar to 5A, although on the horizontal axis is plotted the number of friends (of an asymptomatic user); either only sick ones or any depending on the curve;

FIG. 6 is a visualization of the health and location of a sample of Twitter users (colored circles) and major pollution sources (purple pins) in New York City—each circle shows a person's location on a map, sick people are colored red, whereas healthy individuals are green, and time is displayed with opacity with the brightest markers having been infected most recently;

FIG. 7 is a schematic displaying the health status of people within a social network of a user located at the center, where each line represents a friendship between two people, and the color denotes the health of the corresponding friend;

FIG. 8 is a conditional random field modeling the health of an individual over a number of days (ht), where the observations for each day (oₜ) include day of week, history of sick friends in the near past, the intensity of recent co-location with sick individuals, and the number of such individuals encountered;

FIGS. 9A-9C are plots depicting the precision and recall of three models for predictions made with hindsight (x=0), and up to 8 days into the future (x=8), wherein in plot (a) the effect of social ties is leveraged, in plot (b) the effect of co-locations is leveraged, and in plot (c) both the effect of social ties and the effect of co-locations is leveraged;

FIG. 10 is a visualization of Twitter users (yellow pins) at an airport, where the highlighted individual X indicates that he will be back in 16 days and mentions specific friends for whom this message is relevant; and

FIG. 11 is a flowchart of one aspect of a method of predicting complex phenomena using social networking information.

### DETAILED DESCRIPTION

Traditionally, public health is monitored via surveys and by aggregating statistics obtained from healthcare providers. Such methods are costly, slow, and may be biased. For instance, a person with flu is recorded only after he or she visits a doctor's office and the information is sent to the appropriate agency. Affected people who do not seek treatment, or do not respond to surveys are virtually invisible to the traditional methods.

Recently, digital media has been successfully used to significantly reduce the latency and improve the overall effectiveness of public health monitoring. Perhaps most notably, Google Flu Trends models the prevalence of flu via analysis of geo-located search queries. Other researchers leverage news articles and associated user discussions to monitor infectious diseases.

Twitter itself has been recently shown to accurately assess the overall prevalence of flu independently in a number of countries with accuracy comparable to current state of the art methods including Google Flu and Center for Disease Control and Prevention (CDC) statistics. However, even the state of the art systems suffer from two major drawbacks. First, they produce only coarse, aggregate statistics, such as the expected number of people afflicted by flu in Texas. Furthermore, they often perform mere passive monitoring, and prediction is severely limited by the low resolution of the aggregate approach.

By contrast, according to certain embodiments the methods described herein use a bottom-up approach which takes into account the fine-grained interactions between individuals. Using machine learning techniques applied to the difficult task of detecting ill individuals based on the content of their Twitter status updates, the methods are able to estimate the physical interactions between healthy and sick people via their online activities, and model the impact of these interactions on public health.

It has been demonstrated that micro-blogging data can be used to predict a variety of phenomena, including movie box-office revenues, elections, and flu epidemics. Most research to date has focused on predicting aggregate properties of the population from the activity of the bloggers. A different kind of problem one can pose, however, is to predict the behavior or state of particular individuals within the social network. For instance, one could try to predict whether a person will go to a movie or vote for a particular candidate based on micro-blog data. The individual's own data may or may not be accessible. At one extreme, the task is to predict his behavior or state by considering only data from other people. For example, a person's location can be predicted with a high degree of accuracy based on only the geo-tagged posts (a.k.a. tweets) of his friends on Twitter, although many other types of social information, including but limited to other social media platforms, can be utilized for the methods described herein.

Fine-Grained Computational Epidemiology

If five of friends have flu-like symptoms, and eight people that you've recently met, possibly strangers, have complained about having runny noses and headaches, what is the probability that you will soon become ill as well? Imagine Joe is about to take off on an airplane and quickly posts a Twitter update from his phone. He writes that he has a fever and feels awful. Since Joe has a public Twitter profile the identity of some of his friends is known, and from his GPS-tagged messages some of the places he has recently visited can be seen. Additionally, both a large fraction of the hidden parts of Joe's social network and his latent locations can be inferred by applying the results of previous work, as discussed herein. In the same manner, other people who are likely to be at Joe's airport, or even on the same flight, can be identified. Using both the observed and inferred information, individuals who likely came into contact with Joe, such as the passengers seated next to him, can now be monitored. Joe's disease may have been transmitted to them, and vice versa, though they may not exhibit any symptoms yet. As people travel to their respective destinations, they may be infecting others. Eventually, some of the people will tweet about how they feel, and at least a fraction of the population that actually contracted the disease can be observed. This is just one example of what public health modeling will look like in the very near future.

Research in computational epidemiology to date has concentrated on coarse-grained statistical analysis of populations, often synthetic ones. By contrast, the present work focuses on fine-grained modeling of the spread of infectious diseases throughout a large real-world social network. Specifically, examined herein are the roles that social ties and interactions between specific individuals play in the progress of a contagion. Public Twitter data is just one example (although there are many others), where for every health-related message there are more than 1,000 unrelated ones. This class imbalance makes classification particularly challenging, but presented herein is a framework that accurately identifies sick individuals from the content of online communication.

In one embodiment, it is shown using a sample of 2.5 million geo-tagged Twitter messages that social ties to infected, symptomatic people, as well as the intensity of recent co-location, sharply increases one's likelihood of contracting the illness in the near future. According to another embodiment, described herein is a method to model the interplay of social activity, human mobility, and the spread of infectious disease in a large real-world population, and methods to obtain quantifiable estimates of the characteristics of disease transmission on a large scale without active user participation, thereby allowing one to model and predict the emergence of global epidemics from day-to-day interpersonal interactions.

According to one embodiment is fine-grained prediction of the health of individuals on the basis of such social network data—an important example of the general problem of modeling dynamic properties of participants in large real-world social networks. A robust SVM classifier is utilized to infer the health state of a person based on the content of his or her tweets. A conditional random field (“CRF”) model is then used to predict an individual's health status, using features derived from the tweets and locations of other people. Performance of the CRF is significantly enhanced by including features that are not only based on the health status of friends, but are also based on the estimated encounters with already sick, symptomatic individuals in the dataset, including non-friends. Thus, the model is able to capture the role of location in the spread of an infectious disease, the impact of the duration of co-location on disease transmission, as well as the delay between a contagion event and the onset of the symptoms. Using the Viterbi algorithm to infer the most likely sequence of a subject's health states over time, it is possible to predict the days a person is ill with 0.94 precision and 0.18 recall. These results far outperform alternative models.

These methods can be used to identify disease vectors, trace the transmission between concrete individuals, and ultimately help understand and predict the spread of infectious diseases with fine granularity. The methods provide ways to examine fundamental questions of public health, such as: What roles do co-location and social ties play in the spread of infectious diseases from person to person? How does an epidemic on a population scale emerge from low-level interactions between people in the course of their everyday lives? Can a potentially non-cooperative individual who is a vector of a dangerous disease, i.e., a “Typhoid Mary,” be identified? What is the interaction between friendship, location, and co-location in the spread of communicable diseases?

According to another embodiment, the methods described herein can also be utilized to deploy sickness prevention resources, and for applications that help an individual maintain his or her health. For example, a person predicted to be at high risk of the flu could be specifically encouraged to get the flu vaccine, and recommendations can be made about which places pose a high risk of getting infected.

Importantly, the methods described herein are not limited to the health domain. For instance, it has been shown that the spread of cheating behavior in online computer games exhibits patterns similar to the spread of a disease. The close relationship between the spread of disease and information in general is well-known. By changing the mapping from text to features, the same approach can be used to model and predict the transmission of political ideas, purchasing preferences, or practically any other behavioral phenomena.

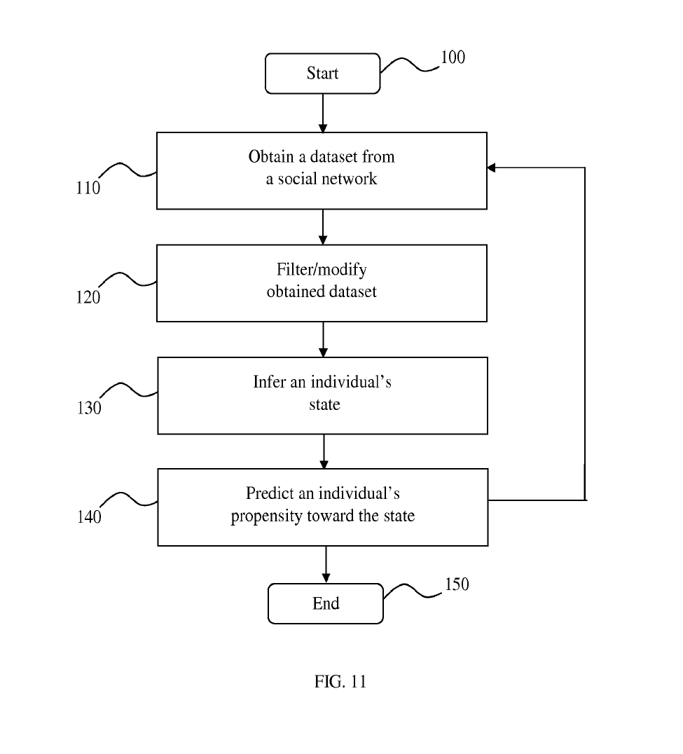

Referring now to the drawings, wherein like reference numerals refer to like parts throughout, there is seen in FIG. 11 a high-level overview of methods for using social network information to predict complex phenomena. At step 110 of the method, a dataset is obtained from a social network or social media source. For example, the data could include information about status, location, relationships, connections, names, email addresses, phone numbers, mailing addresses, IM names, as well as personal information such as date of birth, age, geographic location, education, talents, pets, hometown, skills, career, job, past employment, family status, children, sports, activities and hobbies, or music, television or movie preferences, photographs, or any other demographic, personal, or networking information associated with or describing an individual, as well as other types of information. According to one embodiment, the dataset comprises some form of geo-tagged information.

At step 120 of the method, the dataset is optionally filtered or otherwise modified. For example, only a certain type of information might be included in downstream analysis steps, where this information is identified in a filtering step. According to one embodiment, only individuals with geo-tagged information are included in the modified dataset. According to another embodiment, only individuals who are classified as belonging to or having a certain state will be included in the modified dataset. Alternatively, all information obtained in the previous step will be analyzed in downstream steps.

At step 130 of the method, a Support Vector Machine (“SVM”) classifier is utilized to infer an identified state of an individual, location, or event based on information gathered from a social network dataset. For example, according to one embodiment, one or more SVMs are trained for linear binary classification. The SVMs can be, for example, trained using labeled training data that has been previously obtained.

The methods can stop with the results at step 130, or can continue at step 140. At step 140 of the method, a conditional random field (“CRF”) model is used to predict an individual's propensity toward a state using features derived from the social network dataset. Performance of the conditional random field model can be enhanced by including features that are not only based on the status of network connections, but are also based on the estimated encounters with individuals having the pre-determined state, including individuals other than network connections. According to one embodiment, performance of the CRF is significantly enhanced by including additional features that are not only based on the pre-identified state. For example, location may play a role in the particular state, among many other types of information.

Support Vector Machines

Support vector machine (“SVM”) is an established model of data in machine learning. In this work, SVMs are learned for linear binary classification that accurately distinguish between tweets indicating the author is afflicted by an infectious ailment (called “sick”), and all other tweets (called “other” or “normal”).

Linear binary SVMs are trained by finding a hyperplane defined by a normal vector w with the maximal margin separating it from the positive and negative datapoints. Finding such a hyperplane is inherently a quadratic optimization problem given by the following objective function:

$${min}_{w} \frac{λ}{2} {‖ w ‖}^{2} + ℒ ( w , D )$$

where λ is a regularization parameter controlling model complexity, and [symbol] (w, D) is the hinge-loss over all training data D given by

$$ℒ ( w , D ) = {\sum }_{i} max ( 0 , 1 - {y}_{i} {w}^{T} {x}_{i} )$$

The optimization problem in the objective formula can be solved efficiently and in a parallel fashion using stochastic gradient descend methods.

Class imbalance, where the number of examples in one class is dramatically larger than in the other class, complicates virtually all machine learning. For SVMs, prior work has shown that transforming the optimization problem from the space of individual datapoints <xᵢ, yᵢ> in matrix D to one over pairs of examples:

[symbol]

xᵢ⁺−xⱼ⁻,1

[symbol]

yields significantly more robust results. (xᵢ⁺ denotes feature vectors from the positive class(yᵢ=+1), whereas xⱼ⁻ denotes negatively labeled data points (yᵢ=−1)

This method is often referred to as “ROC Area SVM” because it directly maximizes the area under the ROC curve of the model. By bundling examples into pairs, the modification effectively find a w that minimizes the number nₛ of incorrectly ranked (swapped) pairs in the training data given by:

nₛ=|{(i,j):(yᵢ>yⱼ) [symbol] (w^{T}xᵢ<w^{T}xⱼ)}|

A feature vector xₜ can be classified simply by a dot product multiplication with the weight vector: \tilde{y}=sign (w^{T}xₜ).

### Example 1

In this example, publicly-available Twitter data is utilized to automatically detect message (“tweets”) that suggest the author contracted an infectious disease, and this information is combined with geo, social, and/or other temporal data to extract a strong signal of the impact of various previously elusive factors on human health. A CRF model is then used to leverage the information and make predictions about an individual's health state.

Although this example utilizes publicly-available Twitter data, many other types of data could be similarly utilized. For example, data from other social media or social networking platforms could be used, including but not limited to: Facebook, Twitter, Google+, LinkedIn, Bebo, Orkut, Friendster, MyLife, Classmates.com, Plaxo, Flickr, Last.fm, Myspace, MyHeritage, Foursquare, LiveJournal, Geni.com, XING, Goodreads, and delicious, among many, many others). Further, non-public data could be utilized either by requesting or purchasing access to the data, for example.

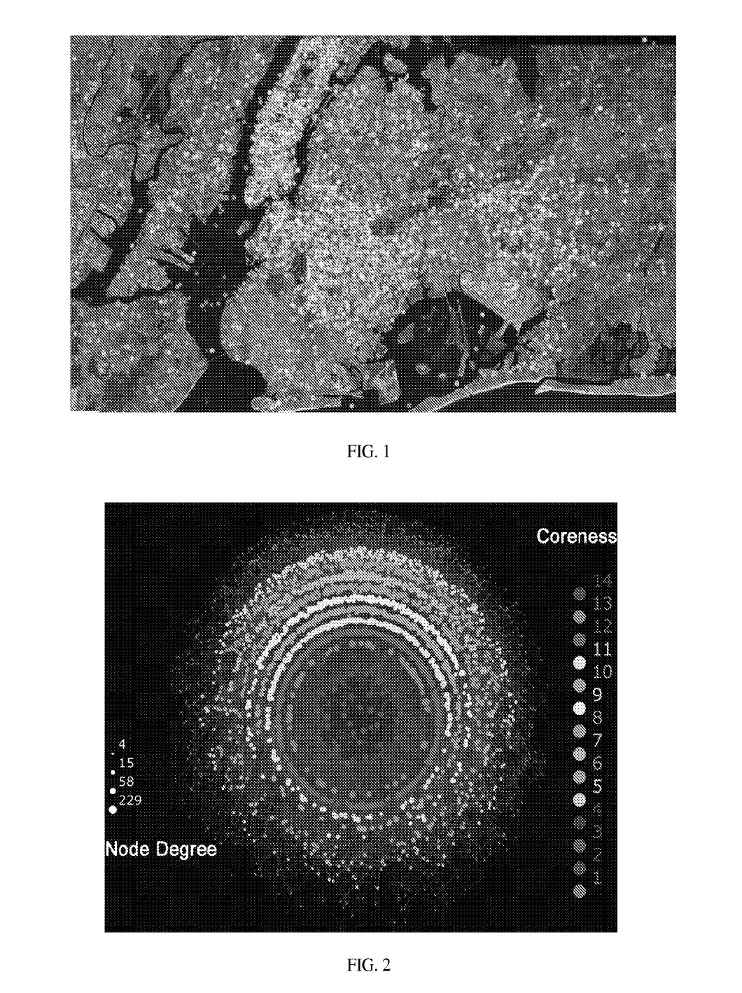

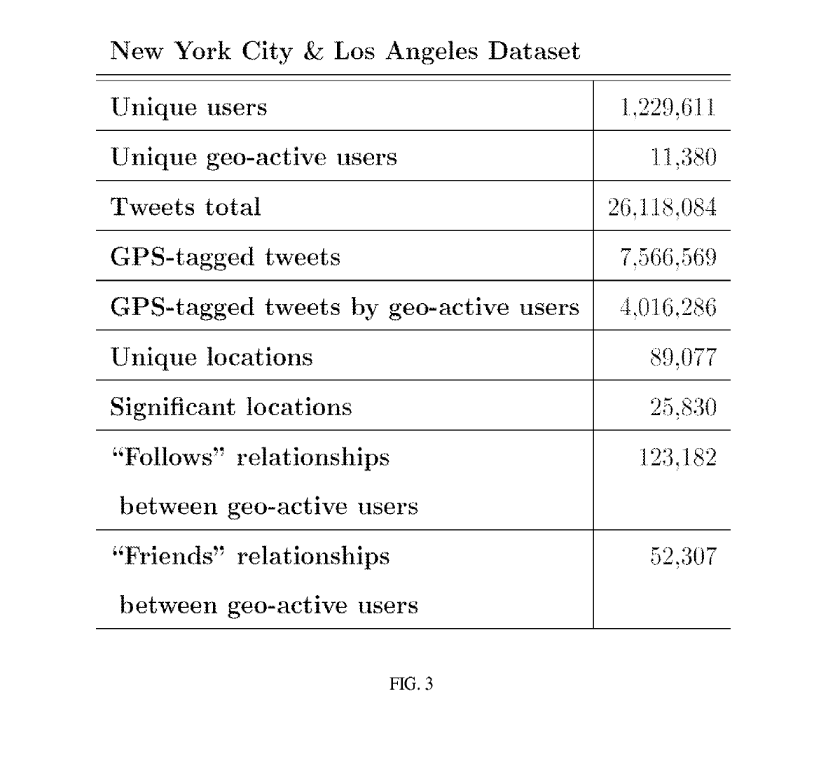

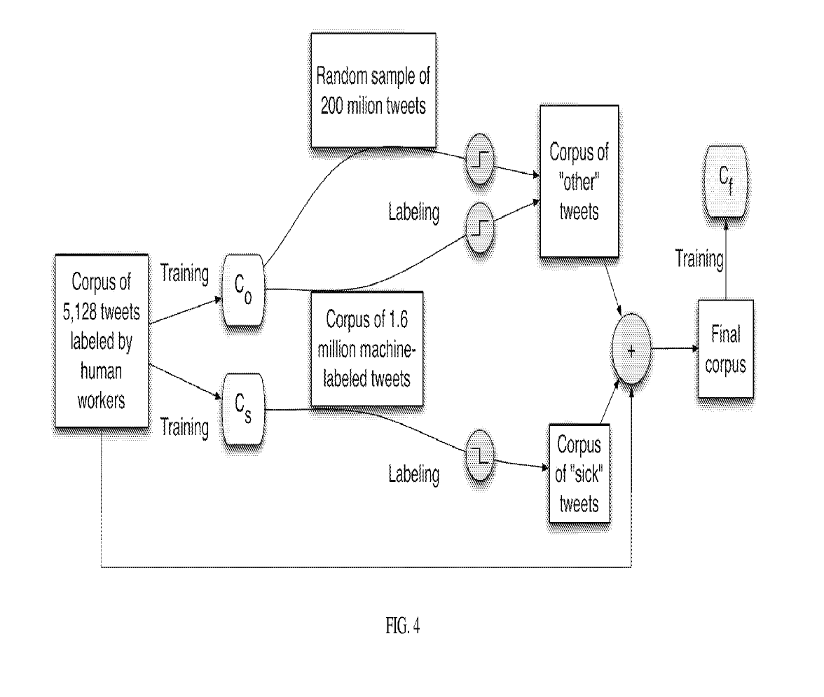

In this example, a subset of the dataset introduced in a previous study (Adam Sadilek, Henry Kautz, and Jeffrey P. Bigham, 2012, “Finding your friends and following them to where you are,” Proceedings of the fifth ACM international conference on Web search and data mining (WSDM 2012), ACM, New York, N.Y., USA, 723-732, the entire contents of which are hereby incorporated by reference), although the subset is briefly reviewed here. Using the Twitter Search API, a sample of public tweets were collected which originated from the New York City (NYC) metropolitan area shown in FIG. 1. The collection period was one month long and started on May 18, 2010. Using a Python script, Twitter was periodically queried for all recent tweets within 100 kilometers of the NYC city center. In order to avoid exceeding Twitter's query rate limits and subsequently missing some tweets, the work was distributed over a number of machines with different IP addresses that asynchronously queried the server and merged their results. Twitter does not provide any guarantees as to what sample of existing tweets can be retrieved through their API, but a comparison to official Twitter statistics shows that our method recorded the majority of the publicly available tweets in the region. Altogether, nearly 16 million tweets authored by more than 630 thousand unique users were logged (see FIG. 3). To put these statistics in context, the entire NYC metropolitan area has an estimated population of 19 million people. The present example concentrated on accounts that posted more than 100 GPS-tagged tweets during the one-month data collection period, which was referred to as geo-active users. The social network of the 6,237 geo-active users is shown in FIG. 2.

In this example, a method for automatic detection of Twitter messages that suggest the author contracted an infectious disease (include those with symptoms that overlap with, but are not necessarily limited to, influenza-like illness) is reviewed. This information is then unified with geo, social, and temporal Twitter data to extract a strong signal of the impact of various previously elusive factors on human health. Finally, a CRF model is developed that leverages the labeled tweets and makes accurate predictions about people's health state.

Detecting Illness-Related Messages

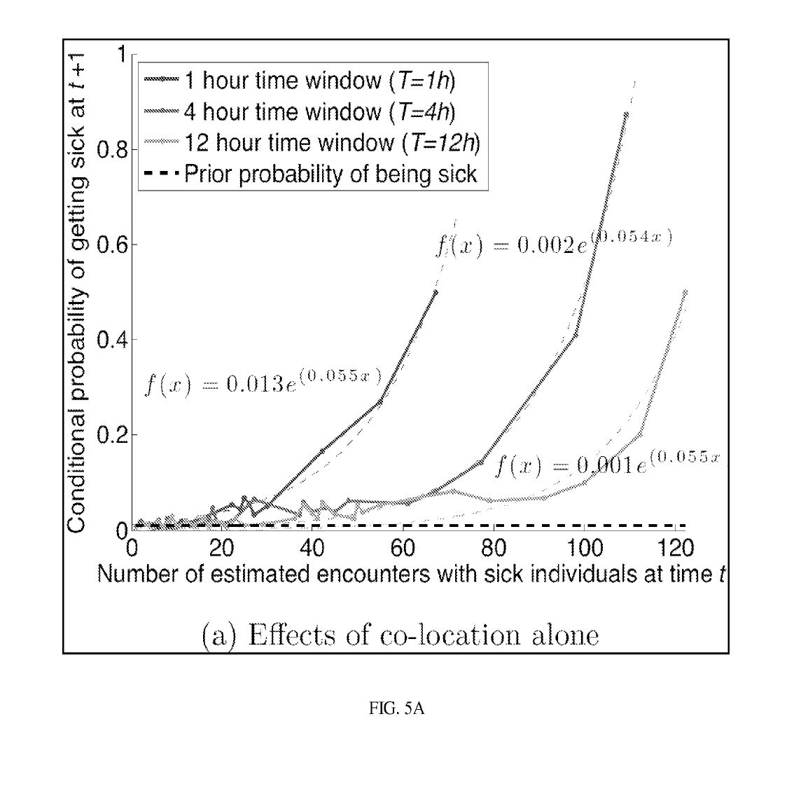

As a first step, Twitter messages that indicate that the author is infected with a disease of interest at the time of posting are identified. Based on the results of previous work, it is expected that health-related tweets are relatively scarce as compared to other types of messages. Given this class imbalance problem, a semi-supervised cascade-based approach is formulated (shown in FIG. 4) to learning a robust support vector machine (“SVM”) classifier with a large area under the ROC curve (i.e., consistently high precision and high recall). SVM is an established model of data in machine learning, and an SVM for linear binary classification is learned in order to accurately distinguish between tweets indicating the author is afflicted by an infectious ailment (“sick”), and all other tweets (“other” or “normal”).

In order to learn such classifier, there was ultimately a need to effortlessly obtain a high quality set of labeled training data. This was achieved via a “bootstrapping” process which began with the training of two different binary SVM classifiers, Cₛ and Cₒ, using the SVM^{light} package. Cₛ is highly penalized for inducing false positives (mistakenly labeling a normal tweet as one about sickness), whereas Cₒ is heavily penalized for creating false negatives (labeling symptomatic tweets as normal). For both classifiers, the misclassification penalty for one direction was always a hundred times larger than in the opposite direction. For purposes of this example, Cₛ and Cₒ were trained using a dataset of 5,128 tweets each labeled as either “sick” or “other” by multiple Amazon Mechanical Turk workers and carefully checked by the authors. After training, the two classifiers were used to label a set of 1.6 million tweets that are likely health-related, but contain some noise. Both Cₛ and Cₒ training datasets were obtained from previous sources, and they are completely disjointed from the NYC data.

The intuition behind this cascading process is to extract tweets that are with high confidence about sickness with Cₛ, and tweets that are almost certainly about other topics with Cₒ from the corpus of 1.6 million tweets. The final corpus is further supplemented with messages from a sample of 200 million tweets (also disjointed from all other corpora considered here) that Cₒ classified as “other” with high probability. Thresholding is applied on the classification score to reduce the noise in the cascade, as shown in FIG. 4.

The cascade yields a final corpus with over 700 thousand “sick” messages and 3 million “other” tweets, which were used for training the final SVM C_{f}. Discussed below is how C_{f} is leveraged to model the disease spread below, but first described is the feature space and the learning methodology in further detail.

As features, all unigram, bigram, and trigram word tokens that appear in the training data are used. For example, a tweet “I feel sick.” is represented by the following feature vector:
(i, feel, sick, i feel, feel sick, i feel sick)
   Before tokenization, all text is converted to lower case, strip punctuation and special characters, and remove mentions of user names (the “@” tag). All re-tweets (analogous to email forwarding) have been removed as well, since those messages typically refer to popular news and social games, and rarely describe the current state of the author. However, hashtags (such as “#sick”) are kept, as those are often relevant to the author's health state, and are particularly useful for disambiguation of short or ill formed messages. When learning the final SVM C_{f}, only considered are tokens that appear at least three times in the training set.

While the feature space has a very high dimensionality (C_{f} operates in more than 1.7 million dimensions), with many possibly irrelevant features, support vector machines with a linear kernel have been shown to perform very well under such circumstances.

To overcome the class imbalance problem, where the number of tweets about an illness is much smaller than the number of other messages, the ROCArea SVM learning method that directly optimizes the area under the ROC curve is applied. Traditional objective functions, such as the 0-1 loss perform poorly under severe class imbalance. For instance, a trivial model that labels every example as belonging to the majority class has an excellent accuracy, because it misses only the relatively few minority examples. By contrast, the ROC Area method works by implicitly transforming the classical SVM learning problem over individual training examples into one over pairs of examples. This allows efficient calculation of the area under the ROC curve from the predicted ranking of the examples.

Patterns in the Spread of Disease

Human contact is the single most important factor in the transmission of infectious diseases. Since the contact is often indirect, such as via a doorknob, the method focuses on a more general notion of co-location. Two individuals are considered co-located if they visit the same 100 by 100 meter cell within a time window (slack) of length T. For clarity, results for Tε{1,4,12} hours are shown. Also used is the 100 meter threshold, as that is the typical lower bound on the accuracy of a GPS sensor in obstructed areas, such as Manhattan. Since geo-active individuals were the focus in this particular example, co-location can be calculated with high accuracy. The results are for a condition, where a person is ill up to two days after they write a “sick” tweet. It is important to note that the relationships among friendship, co-location, and health are consistent over a wide range of duration of contagiousness (from 1 to 7 days). Most infectious illnesses produce influenza-like symptoms that stop within a few days, and thus within these temporal bounds.

To quantify the effect of social ties on disease transmission, users' Twitter friendships are leveraged. Clearly, there are complex events and interactions that take place “behind the scenes”, which are not directly recorded in online social media. However, this example posits that these latent events often exhibit themselves in the activity of the sample of people that can be observed. For instance, having social ties to infected people significantly increases your chances of becoming ill in the near future. However, it is believed that the social ties themselves do not cause or even facilitate the spread of an infection. Instead, the Twitter friendships are proxies and indicators for a complex set of phenomena that may not be directly accessible. For example, friends often eat together, meet in classes, share items, and travel together. While most of these events are never explicitly mentioned online, they are crucial from the disease transmission perspective. However, their likelihood is modulated by the structure of the social ties, allowing us to reason about contagion.

Evaluation of the final SVM C_{f} described herein on a held-out test set of 700,000 tweets shows 0.98 precision and 0.97 recall. This evaluation run also allows us to choose an optimal threshold on the classification score that separates the normal tweets from sick tweets. Table 1 lists the most significant features C_{f} found. Table 2 shows examples of tweets that C_{f} identified as “sick”.

TABLE 1
Top twenty most significant negatively and positively
weighted features of the SVM model in this Example.

| | |
|---|---|
| Positive Features | Negative Features |

| Feature | Weight | Feature | Weight |
|---|---|---|---|
| sick | 0.9579 | sick of | −0.4005 |
| headache | 0.5249 | you | −0.3662 |
| flu | 0.5051 | of | −0.3559 |
| fever | 0.3879 | your | −0.3131 |
| feel | 0.3451 | lol | −0.3017 |
| cough | 0.3062 | who | −0.1816 |
| feeling | 0.3055 | u | −0.1778 |
| coughing | 0.2917 | love | −0.1753 |
| throat | 0.2842 | it | −0.1627 |
| cold | 0.2825 | her | −0.1618 |
| home | 0.2107 | they | −0.1617 |
| still | 0.2101 | people | −0.1548 |
| bed | 0.2088 | shit | −0.1486 |
| better | 0.1988 | smoking | −0.0980 |
| being | 0.1943 | i'm sick of | −0.0894 |
| being sick | 0.1919 | so sick of | −0.0887 |
| stomach | 0.1703 | pressure | −0.0837 |
| and my | 0.1687 | massage | −0.0726 |
| infection | 0.1686 | i love | −0.0719 |
| morning | 0.1647 | pregnant | −0.0639 |

TABLE 2
Sample tweets that the SVM model C_{f} identified
as “sick” in this Example.

Came home sick today from work with a killer headache and severe
nausea, took 2 advil and slept for 6 hours. I feel much better now.
Meh I actually have to go to school tomorrrow . . . #sick
Not feeling good at all . . . that sucks because I plans with my bff and
job interviews set up until Tuesday. Stomach is killing me
I'm feeling better today still stuffed up but my nose isn't running like it
was yesterday and my cough is better as well it hurts
Guys I'm sorry. I'm really have to get some rest. I have nausea, headache,
is tired, freezing & now have I got fever. Good Night! :-*
It hurts to breathe, swallow, cough or yawn. I must be getting sick, though
because my ear feels worse than my throat.
I just sneezed 6 times in a row. i hate being sick.
feeling misserable. stomach hurts, headache, and no, I'm not pregnant.
Been sleep all day smh . . . Currently soothing my jimmy frm a headache
as I go back to Sleep
Just not feeling it today. Looks like man flu has come back for a visit.
I need to be well and have work - is that too much to ask?

C_{f} is then applied to modeling the spread of infectious diseases throughout the sampled population of NYC described above.

The correlation between the prevalence of infectious diseases predicted by our model and the predictions made by Google Flu Trends specifically for New York City is 0.73. The official CDC data for NYC is not available with sufficiently fine granularity, but previous work has shown that Google's predictions closely correspond to the official statistics for larger geographical areas. Google Flu Trends may have greater specificity to “influenza-like illness,” whereas the present approach is also more sensitive to detect other, related infectious processes exhibiting these nonspecific features in Twitter content. Furthermore, the only overlap between our predictions and those of Google is for May 18 through 23, 2010. Thus, the correlation between the two needs to be interpreted with this context in mind.

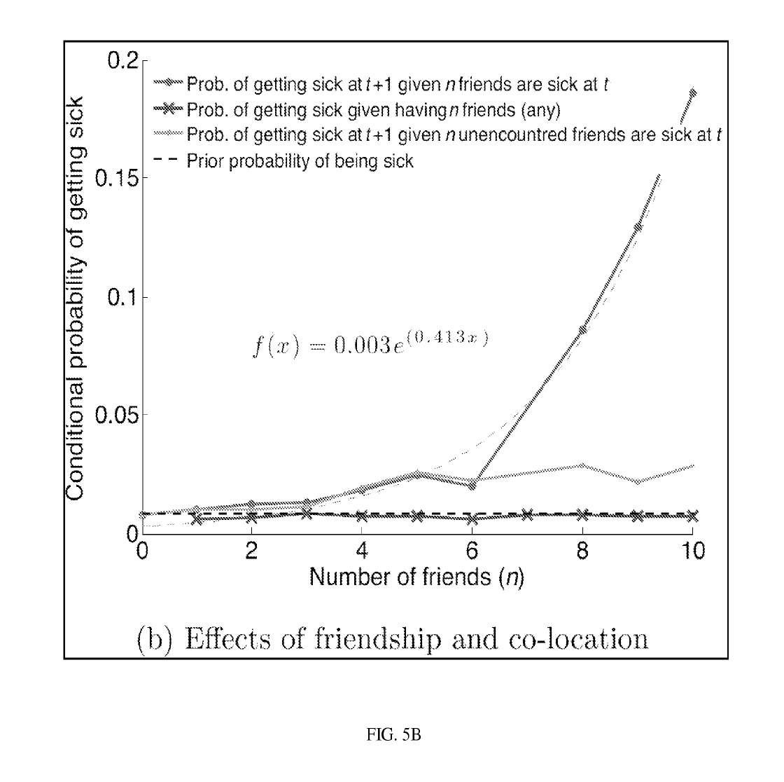

FIGS. 5a and 5b show the impact of co-location and friendship with infected people on a given day on one's health the following day. Both the individual and joint effects of the two factors on disease transmission is analyzed. For brevity, included only are plots only for a 1-day lag, since other time offsets result in a similar relationship.

Looking at co-location effect alone, a definite exponential relationship is observed between probable physical encounters and ensuing sickness. All three curves in FIG. 5a consistently fit f(x)=C e^{(0.055x)}, where C is a constant that captures the length of time overlap T (note that C≈0.011/T; thus the larger the slack the smaller the effect). For instance, having 40 encounters with sick individuals with a 1-hour slack makes one ill with 20% probability. With a more lenient slack, such as 4 hours, one needs over 80 encounters to reach the same level of risk.

In FIG. 5b it is seen that the number of sick friends also has an exponential effect on the probability of getting sick: f(x)=0.003 e^{(0.413x)}. By contrast, the number of friends in any health state (i.e., the size of one's friend list) has no impact on one's health. In fact, the conditional probability of getting sick given n friends (the blue line in FIG. 5b) is virtually identical to the prior probability of getting sick (the black line).

The latent influence of friendships is quantitatively shown as the green line in FIG. 5b, where the effect of co-location is subtracted from the influence of social ties by counting only sick friends who have not been encountered. Comparison with the red curve shows that for smaller numbers of friends (n<6), co-location has a weak additional effect over the proxy effect of social ties. However, for larger n, the residual impact of friendships plateaus, and co-location begins to dominate.

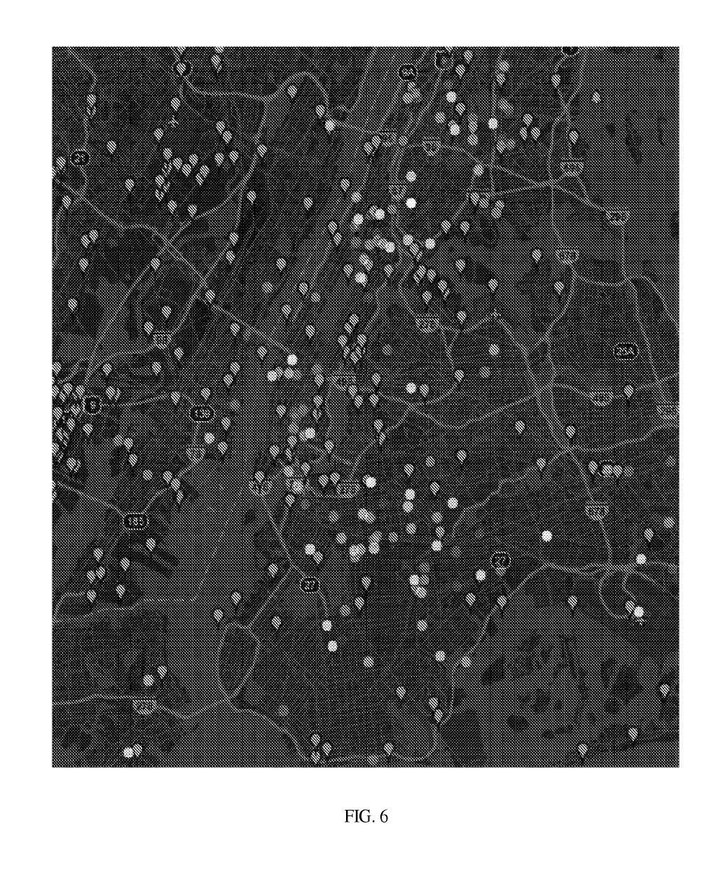

The ability to effortlessly quantify the sickness level for each individual in a large population enables one to gain insights into phenomena that were previously next to impossible to capture. For instance, FIG. 6 shows the relationship between the health of New Yorkers inferred from social media by our system, and pollution sources in the city provided by the U.S. Environmental Protection Agency. It is envisioned that unifications of rich datasets with inferred information in this fashion will empower individuals, organizations, as well as governments to make better informed data-driven decisions.

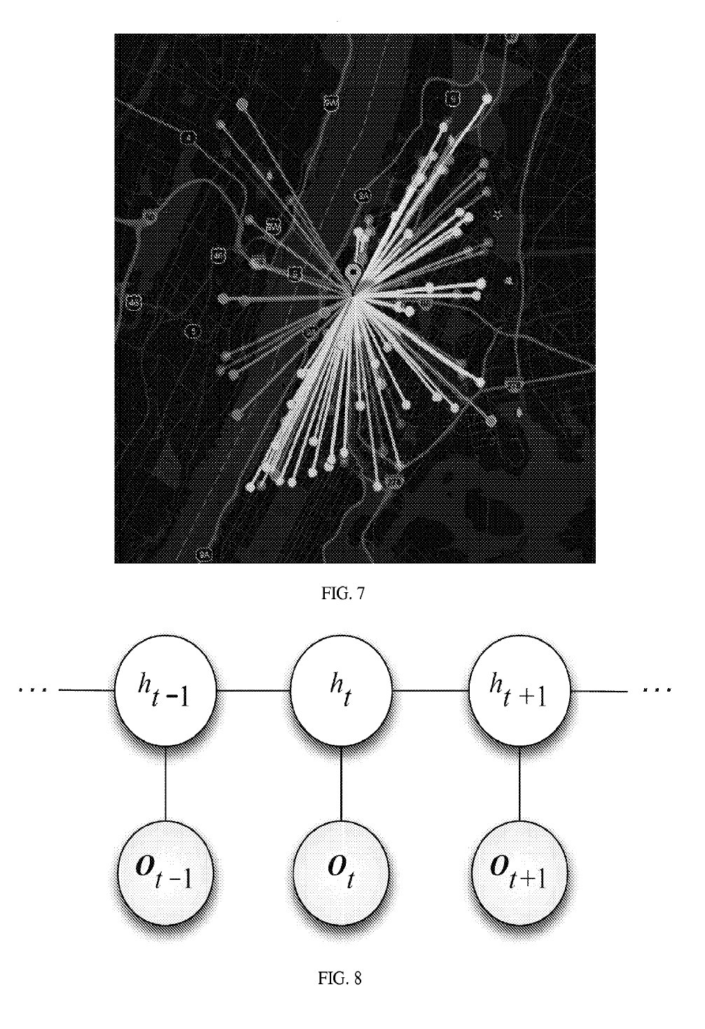

Complex geographical and social patterns can also be explored with fine granularity and at a large scale as shown in FIG. 7. The United States has the world's largest health inequality across the social spectrum, where the gap of life expectancy of the most and the least advantaged segments of the population is over 20 years. It has been well-reported on that this difference is to a large part due to differences in social status. Our work is the first to enable the government as well as individuals to model the interplay between health, location, environment, and social factors effectively and with fine granularity.

Since the sea of information in online social networks can be harnessed as described herein, the health of one's friends and people one encounters can be inferred and displayed in a meaningful way. As a result, one can discover factors that impact one's health and the health of relevant people. Once discovered, undesirable factors can be minimized while maximizing the positive variables.

### Example 2

### Predicting the Spread of Disease

In this example, patterns revealed in the previous example can be leveraged in fine-grained predictive models of contagion. This Example is provided only as a means of describing an embodiment is not meant to be limiting.

Human contact is the single most important factor in the transmission of infectious diseases. Since the contact is often indirect, such as via a doorknob, a more general notion of co-location is the focus. Again, two individuals are considered to be co-located if they visit the same 100 by 100 meter cell within a time window (slack) of length T. For clarity, results are shown for T=12 hours, but virtually identical prediction performance was obtained for Tε{1, . . . , 24} hours. The 100 m threshold was utilized, as that is the typical lower bound on the accuracy of a GPS sensor in obstructed areas, such as Manhattan. Since the focus was on geo-active individuals, co-location could be calculated with high accuracy. The results below are for a condition, where a person is considered ill up to four days after they write a “sick” tweet. As with the parameter T, it is important to note that the results are consistent over a wide range of duration of contagiousness (from 1 to 7 days). Few diseases with influenza-like symptoms are contagious for periods of time beyond these bounds.

Statistical analysis of the data shows that avoiding encounters with infected people generally decreases your chances of becoming ill, whereas a large amount of contact with them makes an onset of a disease almost certain. A definite exponential relationship is found between the intensity of co-location and the probability of getting ill. Similarly, by interpreting a Twitter friendship as a proxy for unobservable phenomena and interactions, it is seen that the likelihood of becoming ill increases as the number of infected friends grows. For example, having more than 5 sick friends increases one's likelihood of getting sick by a factor of 3, as compared to prior probability, and even more with respect to the probability given no sick friends. Additionally, the joint influence of co-location and social ties is modeled, and conclude that the latent impact of friendships is weaker (linear in the number of sick friends), but nonetheless important, as some observed patterns cannot be explained by co-location alone.

The goal was to leverage the interplay of co-location and friendships to predict the health state of any individual on a given day. For this purpose, the method learns a dynamic conditional random field (CRF), a discriminative undirected graphical model. CRFs have been successfully applied in a wide range of domains from language understanding to robotics. They can systematically outperform alternative approaches, such as hidden Markov models, in domains where it is unrealistic to assume that observations are independent given the hidden state.

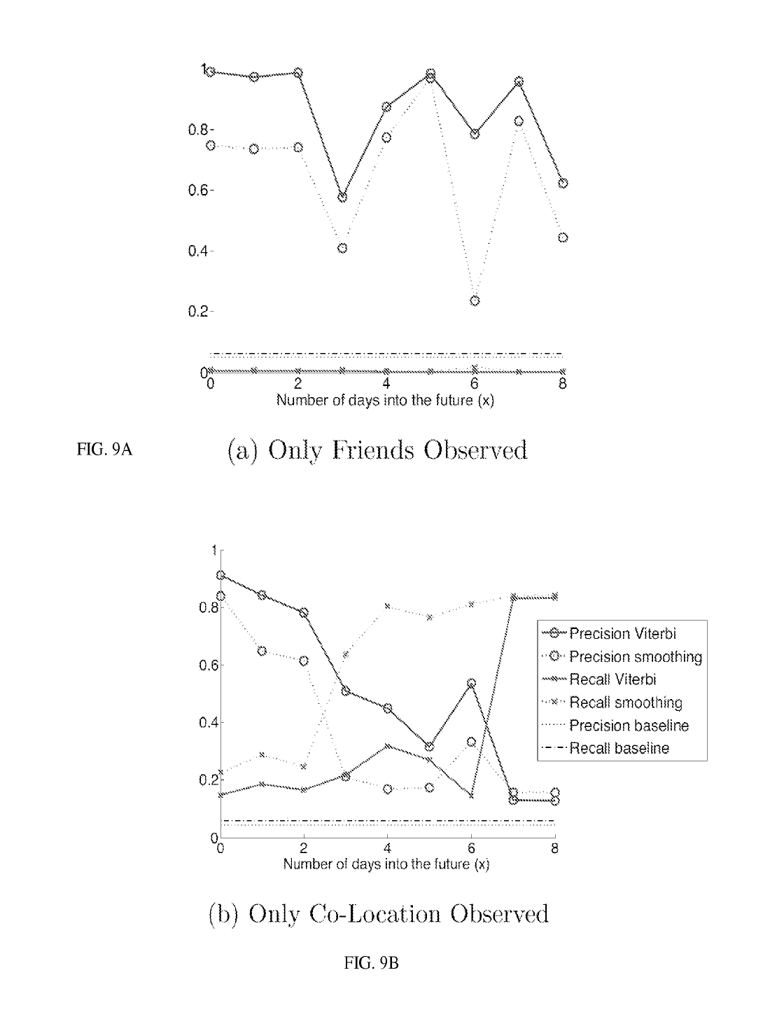

In this example, each person X is captured by one dynamic CRF model with a linear chain structure shown in FIG. 8. Each time slice t contains one hidden binary random variable (X is either “healthy” or “sick” on day t), and a 25-element vector of observed discrete random variables o_{f} given by

oₜ=(weekday,c₀, . . . ,c₇,u₀, . . . ,u₇,f₀, . . . ,f₇),

where cₙ denotes the number of estimated encounters (co-locations) with sick individuals n days ago. For example, the value of c₁ indicates the number of co-location events a person had a day ago (t−1), and c₀ shows co-location count for the current day t. Analogously, uₙ and fₙ denote the number of unique sick individuals encountered, and the number of sick Twitter friends, respectively, n days ago. For all random variables in our model, a special missing value is used to represent unavailable data.

Experiments and Results

In this section, the approach is evaluated in a number of experimental conditions, the results of the CRF models are compared with a baseline, and insights gained are discussed. A 6237-fold cross-validation is performed (the number of geo-active users), where in order to make predictions for a given user, the CRF is trained and tested while treating all other users as observed. Results are reported as aggregated over all cross-validation runs.

While the structure of the CRF model remains constant across our experiments, two types of inference are considered: Viterbi decoding, and the forwards-backwards algorithm (smoothing). While the former finds the most likely sequence of hidden variables (health states) given observations, the latter infers each state by finding maximal marginal probabilities. The tree structure of the CRF allows for scalable, yet exact, learning and inference by applying dynamic programming, while the rich temporal features capture longer-range dependencies in the data. L1 regularization is used to limit the number of parameters in our model. Maximum-likelihood parameter estimation is done via quasi-Newton method, and a global optimum is guaranteed to be found since the likelihood function is convex.

As a baseline, a model is considered that draws its predictions from a Bernoulli distribution with the “success” parameter p set to the prior probability of being sick learned from the training data.

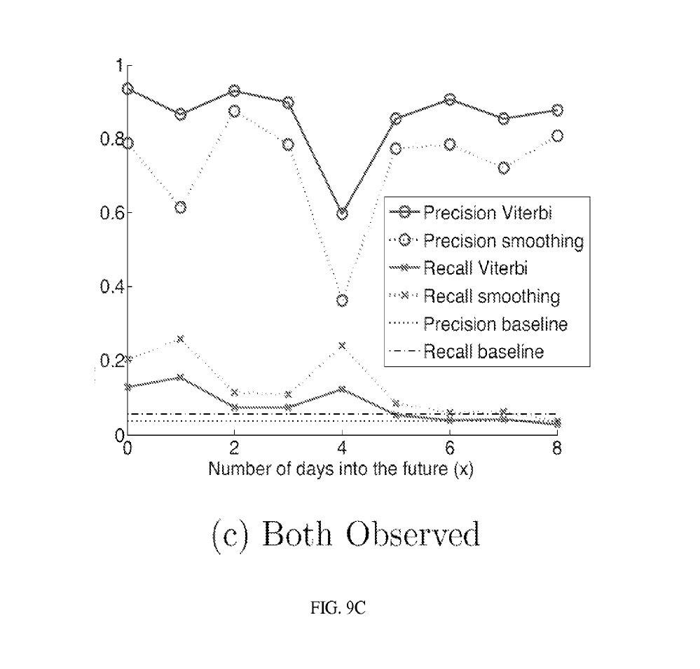

The CRFs significantly outperform the baseline model. When leveraging the effect of social ties or co-locations individually (see FIG. 9), the CRF models perform inconsistently as predictions are made further into the future. By contrast, when considering friendships and co-location jointly, the performance stabilizes and improves, achieving up to 0.94 precision and 0.18 recall (see FIG. 9).

In general, it is shown that Viterbi decoding results in better precision and worse recall, whereas forwards-backwards inference yields slightly worse precision, but improves recall. The relatively low recall indicates that about 80% of infections occur without any evidence in social media as reflected in our features. For example, there are a number of instances of users getting ill even though they had no recent encounters with sick individuals and all their friends have been healthy for a long time.

Limitations

The observations are potentially limited by the prevalence of public tweets in which users talk about their health, and by the ability or inability to identify them in the flood of other types of messages. Both these factors contribute to the fact that the number of infected individuals is systematically underestimated, but evaluation of C_{f} suggests that the latter effect is small. The magnitude of this bias can be approximated using the statistics presented earlier. It is seen that about 1 in 30 residents of NYC appear in our dataset. If the geo-active individuals are strictly focused on, the ratio is roughly 1:3,000. However, as this Example indicates, that by leveraging the latent effects of our observations, such a sampling ratio is sufficient to predict the health state of a large fraction of the users with high precision.

It is noted that currently used methods suffer from similar biasing effects. For example, infected people who do not visit a doctor, or do not respond to surveys are virtually invisible to the traditional methods. Similarly, efforts such as Google Flu Trends can only observe individuals who search the web for certain types of content when sick. A fully comprehensive coverage of a population will require a combination of diverse methods, and application of AI techniques—like the ones presented in this work—capable of inferring the missing information.

Since the famous cholera study by John Snow (1855), much work has been done in capturing the mechanisms of epidemics. There is ample previous work in computational epidemiology on building models of coarse-grained disease spread via differential equations, by harnessing simulated populations, and by analysis of official statistics. Such models are typically developed for the purposes of assessing the impact a particular combination of an outbreak and a vaccination or containment strategy would have on humanity, a country's defense, or ecology. However, the above works focus on simulated populations and hypothetical scenarios. By contrast, the methods here address the problem of assessing and modeling the health of real-world populations composed of individuals embedded in a fine social structure. As a result, these methods are a vital step towards prediction of actual threats and instances of disease outbreaks.

Although others have explored augmenting the traditional notification channels about a disease outbreak with data extracted from Twitter, all these works consider only aggregate patterns captured by coarse-grained statistics, whereas the primary contribution of our work is a more detailed study of the interplay among human mobility, social structure, and disease transmission. The present methods and framework allows one to track—without active user participation—specific likely events of contagion between individuals, and model the relationship between an epidemic and self-reported symptoms of actual users of online social media.

Indeed, prior systems suffer from two major drawbacks. First, they produce only coarse, aggregate statistics, such as the expected number of people afflicted by flu in Texas. Furthermore, they often perform mere passive monitoring, and prediction is severely limited by the low resolution of the aggregate approach, or by scalability issues. By contrast, the primary contribution of the present methods is a fine-grained analysis of the interplay among human mobility, social structure, and disease transmission. The present methods and framework allows one to make predictions about likely events of contagion between specific individuals without active user participation.

While several embodiments concentrate on “traditional” infectious diseases, such as flu, other embodiments can be applied to study mental health disorders, such as depression, that have strong contagion patterns as well. Pioneering work in this broad area includes studies of characteristics of young lesbian, gay, and bisexual individuals in online social networks. They focus on discovering such members of a community, and design methods for effective peer-driven information diffusion and preventative care, focusing specifically on suicide. Twitter has also been used to monitor the seasonal variation in affect around the globe.

Looking at a more global scale, others have argued for a comprehensive scientific approach to urban planning. They show there are underlying patterns that tie together the size of a city with its emergent characteristics, such as crime rate, number of patents produced, walking speed of its inhabitants, and prevalence of epidemics.

Since the present methods and embodiments leverage social ties and user location, the large body of existing work on inferring and predicting these characteristics becomes relevant. A number of researchers have demonstrated that it is possible to accurately predict people's fine-grained location from their online behavior and interactions. Much progress has been made in predicting the social structure of participants in online media, including Twitter, from various types of observed data. Applying these machine learning techniques will significantly expand the breadth of data available by allowing us to consider not only declared friendships and public check-ins, but also their inferred—though more ambiguous—counterparts.

Finally, it is noted that the spread of disease is closely tied to the study of influence in social networks, where the usual goal is to identify the most influential members to facilitate information diffusion. However, similar techniques can be applied to detect and treat key people in an epidemic. Both social structure and location of individuals—the two main focus areas of our unified model—have been shown to play major roles in epidemiology, but have been studied only at an aggregate level.

According to embodiments of the methods described herein, prediction of the spread of infectious diseases throughout a real-world population with fine granularity is possible. By focusing on self-reported symptoms that appear in people's Twitter status updates, and showing that although such messages are rare, they can be identified systematically with high precision and high recall.

According to an embodiment is a scalable probabilistic model that demonstrates that the health of a person can be accurately inferred from her location and social interactions observed via social media. Furthermore, future health states can be predicted with consistently high accuracy more than a week into the future. For example, over 10% of cases of sickness are predicted with 90% confidence even a week before they occur. For predictions one day into the future, the methods cover almost 20% of cases with the same confidence.

An early identification of infected individuals is especially crucial in preventing and containing devastating disease outbreaks. Important work shows that by far the most effective way to fight an epidemic in urban areas is to quickly confine infected individuals to their homes. However, this strategy is truly effective only when applied early on in the outbreak. The speed of targeted vaccination ranks second in effectiveness. According to the methods described herein, finding some of these key symptomatic individuals, along with other people that may have already contracted the disease, can be done effectively and in a timely manner through social media.

In other embodiments, larger geographical areas (including airplane travel) are examined while maintaining the same level of detail (i. e., social ties between concrete individuals and their fine-grained location). This allowsone to model and predict the emergence of global epidemics from the day-to-day interactions of individuals, and subsequently answer questions such as “How did the current flu epidemic in city A start and where did it come from?” and “How likely I am to catch a cold if I visit the mall?”

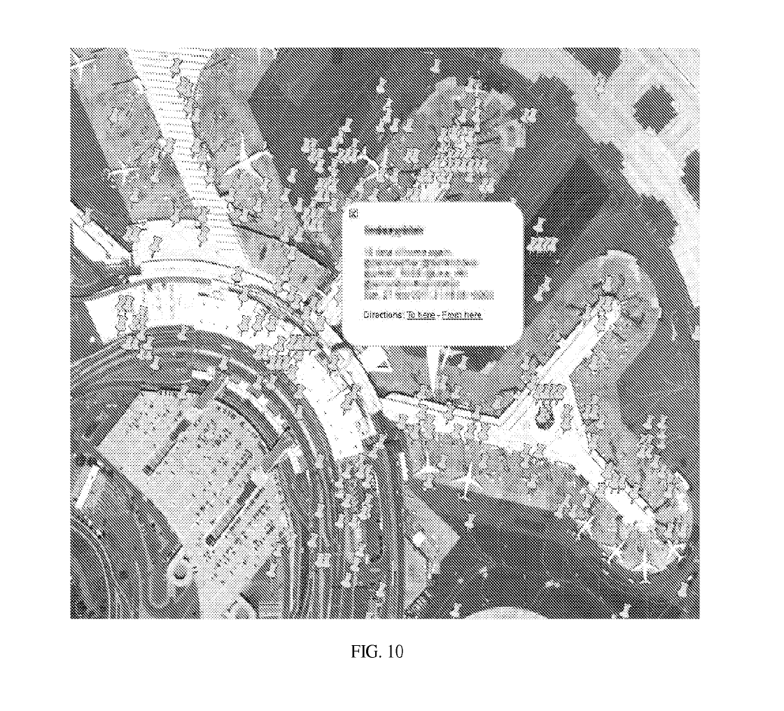

For example, FIG. 10 illustrates a particular instance in the present dataset, where a sick person at an airport posts a message, and other people nearby can be seen with whom he could have come into contact. Prior work has developed a repertoire of powerful AI techniques for revealing hidden social ties and predicting user location—two features heavily leveraged by our public health model. Therefore, there are opportunities for great synergy in these areas.

Although the present invention has been described in connection with a preferred embodiment, it should be understood that modifications, alterations, and additions can be made to the invention without departing from the scope of the invention as defined by the claims.

What is claimed is:

1. A method for predicting an individual's propensity for a state using social media content items, the method implemented by a computer having a processor and system memory, the method comprising:
identifying a plurality of social media content items, each social media content item comprising an author, wherein at least one of said social media content items comprises location information;
creating a subset of said identified plurality of social media content items, wherein said subset comprises social media content items that indicate that the author comprises said state, and that comprises location information;
determining whether the individual was co-located in space with one or more of the authors in said subset;
calculating a confidence score indicative of the individual's propensity for said state based on said co-location determination; and
delivering the individual's propensity for said state to said individual.

2. The method of claim 1, wherein said determining step further comprises determining whether the individual was co-located in space with one or more of the authors in said subset within a predetermined period of time.

3. The method of claim 1, wherein said creating step comprises classification of said identified plurality of social media content items using a support vector machine binary classifier.

4. The method of claim 3, wherein said identified plurality of social media content items are tokenized before being classified.

5. The method of claim 1, wherein the individual and one or more of the authors in said subset are determined to be co-located in space if they were co-located in a predetermined proximity to one another.

6. The method of claim 1, wherein the individual and one or more of the authors in said subset are determined to be co-located in space if they were co-located in a predetermined proximity to one another within a predetermined time window.

7. The method of claim 5, wherein said predetermined proximity is a 100 by 100 meter cell.

8. The method of claim 6, wherein said predetermined time window is between approximately one hour and seven days.

9. The method of claim 1, further comprising the step of:
determining whether one or more of the authors in said subset have a connection to said individual.

10. The method of claim 9, wherein said calculating step is also based on whether one or more of the authors in said subset have a connection to said individual.

11. The method of claim 9, wherein said connection is a digital or non-digital relationship.

12. A system for predicting an individual's propensity for a state using social media content items, the system comprising:
a computer having a processor and system memory;
a plurality of social media content items, each social media content item comprising an author, wherein at least one of said social media content items comprises location information; and
a classifier adapted to create in said system memory a subset of said identified plurality of social media content items, wherein said subset comprises social media content items that indicate that the author comprises said state, and that comprises location information;
a determination engine adapted to determine whether the individual was co-located in space with one or more of the authors in said subset; and
a calculator adapted to calculate a confidence score indicative of the individual's propensity for said state based on said co-location determination.

13. The system of claim 12, wherein said determination engine is further adapted to determine whether the individual was co-located in space with one or more of the authors in said subset within a predetermined period of time.

14. The system of claim 12, wherein said classifier is a support vector machine binary classifier.

15. The system of claim 12, further comprising a tokenizer adapted to tokenize said identified plurality of social media content items.

16. The system of claim 12, wherein said determination engine is further adapted to determine whether the individual and one or more of the authors in said subset were co-located in a predetermined proximity to one another within a predetermined time window.

17. The system of claim 16, wherein said predetermined proximity is a 100 by 100 meter cell.

18. The system of claim 16, wherein said predetermined time window is between approximately one hour and seven days.

19. The system of claim 12, wherein said determination engine is further adapted to determine whether one or more of the authors in said subset have a connection to said individual.

20. A method for predicting an individual's propensity for a health condition using social media content items, the method implemented by a computer having a processor and system memory, the method comprising:
identifying a plurality of social media content items, each social media content item comprising an author, wherein at least one of said social media content items comprises location information;
tokenizing said identified plurality of social media content items;
creating a subset of said identified plurality of social media content items using a support vector machine binary classifier, wherein said subset comprises social media content items that indicate that the author comprises said health condition, and that comprises location information;
determining whether the individual was co-located in space with one or more of the authors in said subset within a predetermined period of time;
determining whether one or more of the authors in said subset have a connection to said individual;
calculating a confidence score indicative of the individual's propensity for said health condition based on said co-location and connection determinations; and
delivering the individual's propensity for said health condition to said individual.
